(19) United States
(12) Patent Application Publication
(10) Pub. No.: US 2008/0004983 A1
(43) Pub. Date: Jan. 3, 2008

(54) TRANSACTION SYSTEM AND METHOD

(75) Inventor: Steven COHN, Hoboken, NJ (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: B601 FOGGY BOTTOM LLC, Dover, DE (US)

(21) Appl. No.: 11/764,777

(22) Filed: Jun. 18, 2007

Related U.S. Application Data
(60) Provisional application No. 60/813,819, filed on Jun. 16, 2006.

(51) Int. Cl. G06Q 30/00

(52) U.S. Cl. 705/26

(57) ABSTRACT

A transaction method and system includes a method for redeeming an item that includes providing a receiving step wherein a person who is to receive an item receives a notice of the item, the notice including a confirmation code; and a redeeming step wherein the person uses the confirmation code to redeem the item. Additionally, the method can include an accessing step wherein the person accesses a designated website; a submitting step wherein the person inputs the confirmation code at the designated website; and a selecting step wherein the person then selects an item redeeming option.

### CROSS-REFERENCE TO RELATED APPLICATION

This application is related to and claims priority to U.S. Provisional Patent Application Ser. No. 60/813,819, filed Jun. 16, 2006, entitled Buy Your Friend a Drink Network Model, the entirety of which is incorporated herein by reference.

### STATEMENT REGARDING FEDERALLY SPONSORED RESEARCH OR DEVELOPMENT

n/a

### FIELD OF THE INVENTION

The present invention relates to a system and method for making online transactions, including the purchasing and redemption of items.

### BACKGROUND OF THE INVENTION

Most often a sale is conducted such that a buyer travels to a seller's place of business and makes a payment in exchange for an item. Typically, the item is not intended for use at its place of business. Thus, the buyer has to physically transport the item to its place of intended use. The task of transporting the item can be difficult and inconvenient. Therefore, there is a need for an easy to use system that permits purchase of an item to be made at one location and redemption of the item at another.

Shopping at a seller's place of business requires traveling to a store and attempting to locate the item desired. Many times the seller does not sell the desired item and other times the seller has sold out of the item desired. A potential buyer may end up traveling to several stores before locating the desired item. Even after the item desired is purchased, the buyer may incur additional expenses, such as packaging and shipping. In addition to being costly, packaging and shipping can be time consuming.

In another type of transaction, it is desired to send the purchased item to a location other than the buyer's residence, such as when giving gifts. At times, it may be that the buyer wants the item delivered to this other location in a short amount of time. Package couriers charge a premium to deliver items in a shorter time than usual. Thus, there is a need for an alternative means of receiving an item at a location other than the seller's place of business in a short amount of time.

Online shopping is becoming increasingly popular as users become more comfortable with and trusting of the Internet. Although online shopping offers buyers a convenient way to shop, items purchased online can become more expensive because of additional shipping charges. Moreover, the time between purchase and receipt of the item is longer when items are bought online versus when an item is bought at a seller's place of business. For these reasons, buyers may wish to make purchases online and pick-up the item at the seller's place of business. However, in today's marketplace many limitations exist on transactions of this manner because there is a lack of a central database. Such limitations include the items purchased, the time of redemption, and the place of redemption. It would therefore be desirable to provide improved transactions systems and methods of making transactions.

### SUMMARY OF THE INVENTION

The present invention advantageously provides a method and system for redeeming an item that includes providing a receiving step wherein a person who is to receive an item receives a notice of the item, the notice including a confirmation code; and a redeeming step wherein the person uses the confirmation code to redeem the item. Additionally, the method can include an accessing step wherein the person accesses a designated website; a submitting step wherein the person inputs the confirmation code at the designated website; and a selecting step wherein the person then selects an item redeeming option.

The present method also provides a method of buying an item that includes providing an accessing step wherein a buyer accesses a designated website; a buying step wherein the buyer enters information to buy an item; a storing step wherein the information is stored in a database; and a notifying step wherein the database sends a notice of the item to a person, the notice including a confirmation code.

The present invention further provides a method of item giving that includes providing an accessing step wherein a buyer accesses a designated website; a buying step wherein the buyer enters information to buy an item; a storing step wherein the information is stored in a database; a notifying step wherein the database sends a notice of the item to a person; a receiving step wherein the person receives the notice, the notice including a confirmation code; and a redeeming step wherein the person uses the confirmation code to redeem the item.

Still further, the present invention provides a system for consumer-to-consumer item giving that includes providing a designated website that is accessible via the internet; a buying device, such as an online form, that allows a buyer to enter information to buy an item; a database that stores the information into a storage device, such as computer memory; a confirmation code generating device, such as a computer application, that generates a confirmation code; a notifying device, such as a modem, that sends a notice of the item to a person; a receiving device, such as a cell phone, that allows the person to receive the notice, the notice including the confirmation code; and a redeeming device, such as an online form, that accepts the confirmation code to redeem the item.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a schematic illustration of a transaction system;

FIG. 2 is block diagram illustrating a method of redemption in accordance with the invention;

FIG. 3 is a block diagram illustrating an embodiment of an exemplary step in the method of redemption of FIG. 2;

FIG. 4 is a block diagram illustrating an embodiment of an exemplary selecting step in the method of redemption;

FIG. 5 is another embodiment of an exemplary step in the method of redemption of FIG. 2;

FIG. 6 is a block diagram illustrating a method of buying an item in accordance with the invention;

FIG. 7 is a block diagram of a transaction method in accordance with the invention;

FIG. 8 illustrates an embodiment of the redemption system in accordance with the invention; and

FIG. 9 shows an alternate embodiment of the redemption system in accordance with the invention.

### DETAILED DESCRIPTION OF THE INVENTION

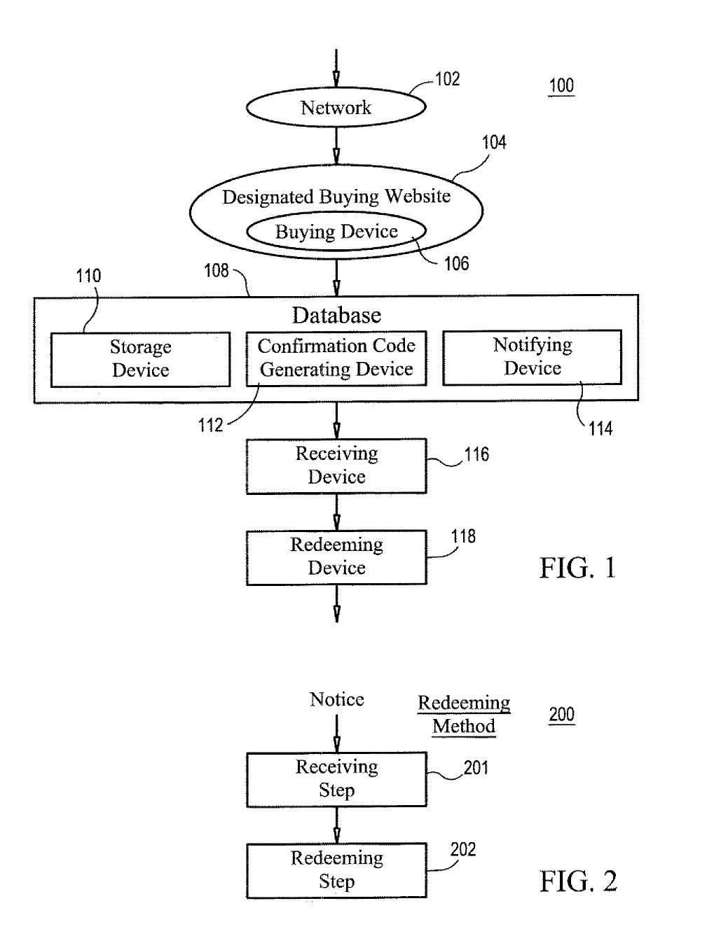

Referring now to the drawing figures in which like reference designators refer to like elements, there is shown in FIG. 1 a diagram of an exemplary transaction system constructed in accordance with the principles of the present invention and designated generally as “100”. The transaction system 100 allows for the purchase and redemption of items in the embodiments described herein. Herein, item is used to refer to any good, service, or monetary amount. Further, the described transaction system 100 is suitable for transactions in a range of industries and settings.

The depicted transaction system 100 includes a network 102, at least one designated website 104 having at least one buying device 106, a database 108 having at least one storage device 110, a confirmation code generating device 112, a notifying device 114, a receiving device 116, and a redeeming device 118.

The network 102 may be the Internet. Thus, this network can be accessed from many different locations using many different types of input devices, such as personal computers, smart-phones and the like. The designated website 104 can be any website on the network 102. Furthermore, this designated website 104 is accessible to anyone with Internet access and promoted so that the general public knows how to reach the designated website 104.

Once at the designated website 104, a buyer has numerous options. One option is for the buyer to access a buying device 106, such as an online form. Thus, the buying device 106 may be accessed via a communication device with Internet access, such as a PDA, smart-phone, or laptop. The buying device 106 allows a buyer to enter information. This information may include, but is not limited to, the type of item or a dollar denominated gift, the name of the buyer, contact information of the buyer, the name of a recipient, and contact information for the recipient, such as the recipient's email address and/or phone number.

The buying device 106 is coupled to a database 108. The database 108 includes at least one storage device 110, which may be any type of computer memory known in the art. It is in this storage device 110 that the information entered into the buying device 106, is retained. The database 108 is also coupled to a confirmation code generating device 112. This confirmation code generating device 112 may be a computer application that is stored on a computer readable medium. The confirmation code generating device 112 acts to generate a confirmation code. The confirmation code may be a word, a sequence of letters, a number, a symbol, or an alphanumeric code or signal. Additionally, the confirmation code may be randomly generated or randomly selected from a previously compiled list. Or the confirmation code may be one code in a series of codes that are in an alphabetical, numerical, or alphanumerical order. The confirmation code generating device 112 is coupled to a storage device 110 of the database 108, so that the generated confirmation code can be stored. Moreover, the confirmation code can be stored, so that it is valid for a specified time and/or place.

The confirmation code generating device 112 is also coupled to a notifying device 114, either directly or indirectly via the database 108. The notifying device 114 is any device that is capable of interfacing with any communication system, including the Internet and telephone system, in order to transmit the confirmation code and/or any additional text or voice data. For example, the notifying device 114 may be a modem. Furthermore, the notifying device 114 may be capable of encrypting the data to be transmitted. The notifying device 114 may utilize any of the various encryption techniques used in the art.

The notifying device 114 transmits a notice, including the confirmation code, via a network to a receiving device 116. The receiving device 116 may be an email address, cell phone, home phone, satellite phone, pager, PDA, smart-phone, or other similar communication device, physical gift card (sent by mail). Thus, the notice may take the form of a text message, email, voicemail, or similar form of communication. In addition to the confirmation code, the notice may include information obtained through the buying device 106 or generated by the database 108.

Once a recipient receives the notice through the receiving device 116, the recipient can access a redeeming device 118 controlled by the retailer. This redeeming device 116 may be a website or a network of retailers who have chosen to accept the gift code. The redeeming device 116 designates a site, either a website, an online form, an online field, or a physical site, where the confirmation code can be provided and the item purchased can be redeemed. Redeeming an item may include providing the recipient with the item, providing the recipient with a symbolic form of the item, providing the recipient with a receipt for the item, transferring the item to another location, forwarding the item, or reserving the item.

FIG. 2 shows one embodiment of a method for redeeming an item. The method for redeeming an item has two main steps: a receiving step 201 and a redeeming step 202. The receiving step 201 designates the receiving of a notice of the item by a recipient. The recipient may receive the notice via an email, text message, voice message, or other similar form of communication. The recipient may receive this notice through the use of a computer, laptop, cell phone, home phone, satellite phone, pager, PDA, smart-phone, or other similar communication device, or a physical gift card sent by mail. The notice may include a confirmation code and additional information, such as a message and/or web address. After the receiving step 201, the recipient initiates the redeeming step 202 described in more detail below.

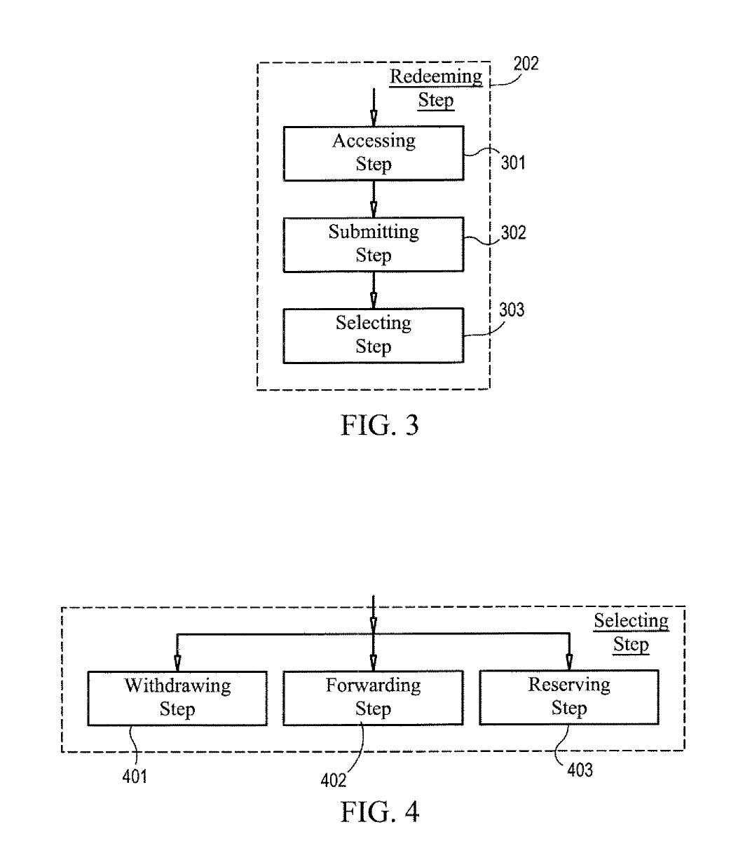

FIG. 3 illustrates one embodiment of the redeeming step 202. In this particular embodiment, the redeeming step 202 includes an accessing step 301, a submitting step 302, and a selecting step 303. The accessing step 301 is the step in which the recipient accesses a designated redeeming website. This designated redeeming website may be the same as the designated buying website or it can be a separate website. It is contemplated that this accessing step 301 may be performed by inserting a web address for the designated redeeming website into a web browser or by selecting a hyperlink contained in the notice. Once at the designated redeeming website, the recipient performs the submitting step 302. In the submitting step 302, the recipient inputs the confirmation code and potentially other information, such as the recipient's name, email address, phone number, etc. Upon completion of the submitting step 302, the recipient begins the selecting step 303.

The selecting step 303 is illustrated in FIG. 4. In the selecting step 303, the recipient selects an item redeeming option. Item redeeming options include a withdrawing step 401, a forwarding step 402, and a reserving step 403. One of these redeeming options is selected based on the recipient's input. A recipient may input his/her selection by any foreseeable means of inputting data into a website such as clicking, typing, or speaking. For example, the recipient can select one of these redeeming options by clicking on a hyperlink. The recipient's selection may initiate the withdrawing step 401. In the withdrawing step 401, the recipient may choose to directly deposit the item into a specific bank account. The recipient may provide a bank account number, routing number, and/or other bank information that allows the item to be transferred from a bank account of either the buyer or a bank account associated with the database 108. Alternatively, the withdrawing step 401, may allow the recipient to deposit the item into a PayPal® account. As opposed to initiating the withdrawing step 401, the selecting step 303 may initiate a forwarding step 402. The forwarding step 402 permits the recipient to forward the item to a second recipient. Thus, the forwarding step 402 allows a recipient to re-gift an item. Completion of the forwarding step 402 initiates the storing step 603 described in more detail below. Returning to the selecting step 303, the recipient may select to initiate the reserving step 403. The reserving step 403 deposits the item into a designated account for later use. The designated account may be a bank account or a virtual account. The reserving step 403 thus allows the user to exchange smaller items for larger ones.

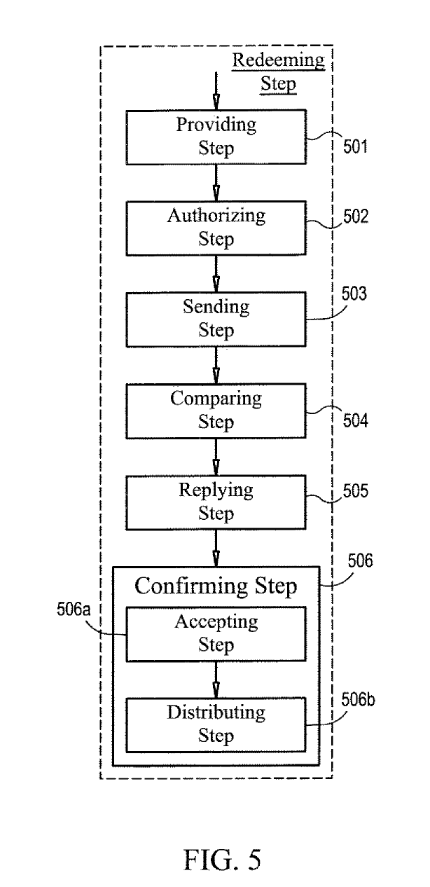

FIG. 5 illustrates another embodiment of the redeeming step 202. This particular embodiment includes a providing step 501, an authorizing step 502, a sending step 503, a comparing step 504, a replying step 505, and a confirming step 506. Recall, that this redeeming step 202 is performed by the recipient. This embodiment of the redeeming step 202 begins with the recipient providing the confirmation code to a retailer. A retailer may be any business where items are located. For example, if the item is an alcoholic drink, then a retailer includes any bar, restaurant, club, or other location that sells alcoholic drinks. Generally the retailer will belong to a network of pre-registered retailers. These pre-registered retailers may have completed required forms and have been enlisted in the database 108.

Upon completion of the providing step 501, an authorizing step 502 is performed. In the authorizing step 502, the confirmation code is input into an authorizing device. An authorizing device may be a keypad, a point of sale device, a credit card terminal, etc. Once the confirmation code is input, a sending step 503 is performed wherein the authorizing step sends a message to the database 108. The sending step 503 may transmit this message over any communication network, including the internet and telephone network. Furthermore, this message may be in the form of text, voice, or other stream of data capable of relaying the confirmation code. Moreover, the message may be encrypted such that the confirmation code is protected as it travels through the communication network.

The sending step 503 is followed by a comparing step 504, which is performed by a comparing device coupled with the database 108. In the comparing step 504, the message is compared with data stored in a storage device 110 coupled with the database 108. This comparison may be performed automatically by any of the known computer implemented algorithms. The comparing step 504, determines whether or not the confirmation code is valid. After completion of the comparing step 504, a replying step 505 generates a reply which includes whether or not the confirmation code is valid, the amount of the item, and any corresponding message. The replying step 505 then sends the reply to the authorizing device. Upon receipt of the reply, the confirming step 506 is performed in which it is confirmed whether the recipient accepts or declines the item. The confirming step 506 comprises an accepting step 506a and a distributing step 506b. In the accepting step 506a, the retailer uses the authorizing device to accept or decline the item. If the retailer accepts the item, then a payment is automatically sent to the retailer. Such mode of payment may include a check, electronic wire transfer, or a credit card payment. In the distributing step 506b, if the retailer accepts via the authorizing device, then the retailer distributes the item. For example, if the item is a drink then the retailer distributes the drink to the recipient.

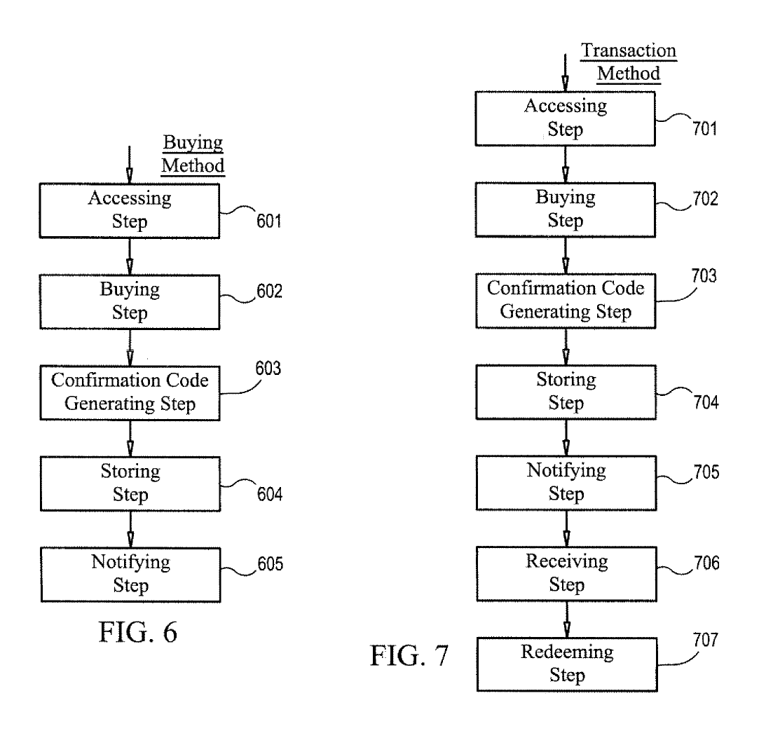

FIG. 6 illustrates the method of buying an item including an accessing step 601, a buying step 602, a confirmation code generating step 603, a storing step 604, and a notifying step 605. In the accessing step 601, a buyer accesses a designated buying website. Once at the designated buying website, a buying step 602 is performed in which the buyer enters information to buy an item. Such information may include the buyer's name, the buyer's email address, the buyer's credit card information, a recipient's name, a recipient's email address, a recipient's phone number, an item amount, and a note. The note may be a text message or voice message, such as “Happy Birthday.” Next, in a confirmation code generating step 603, a confirmation code is generated. In the storing step 604, the information entered is stored in storage device 110 coupled to the database 108. The storing step 604 also stores the generated confirmation code in such a manner as to associate the confirmation code with the information entered by the buyer. Finally, in the notifying step 605 the database 108 sends a notice of the item to the item recipient. The notice at a minimum includes the generated confirmation code.

Now referring to FIG. 7, the method of buying an item and the method of redeeming an item are illustrated in combination to comprise a method of transaction. The method of transaction includes an accessing step 701, a buying step 702, a confirmation code generating step 703, a storing step 704, a notifying step 705, a receiving step 706, and a redeeming step 707.

In an exemplary embodiment the method of transaction can be used to make a gift, such as a beverage (e.g., and alcoholic drink) that can be redeemed by the recipient of the gift at the recipient's convenience (such as at a bar or restaurant). As part of the method, a buyer accesses a designated website 701. At this designated website, a buying step 702 is performed when the buyer inputs information such as the buyer's name, the buyer's credit card information, a recipient's name, a recipient's email address, a recipient's cell phone number, and a dollar amount for the recipient to use towards buying a drink. After entering this information, a confirmation code is generated in a confirmation code generating step 703. The information and confirmation code are then stored in a database for later access in what is referred to as the storing step 704. Next, a notifying step 705 is initiated for notifying the recipient that a drink has been purchased for them by the buyer. In the notifying step 705 a notice including the confirmation code is sent to the recipient via a communication network, such as the Internet or telephone network. Thus, the recipient may be notified of the purchased drink via either email or a text message.

In the receiving step 706, the recipient may receive the notice using a communication device, such as a cell phone, PDA, smart-phone, etc. At this point the recipient begins a redeeming step 707.

In one embodiment the redeeming step 707 may comprise of an accessing step where the recipient accesses a designated website. Once at the designated website the recipient can enter the confirmation code in a submitting step. Following the submitting step, the recipient performs a selecting step where the recipient chooses to either withdraw, forward, or reserve the drink amount. If the recipient selects to withdraw the drink amount, then a withdrawing step is initiated in which the drink amount is deposited into a bank account or PayPal® account provided by the recipient. If the recipient selects to forward the drink amount, then a forwarding step is initiated in which the drink amount is forwarded to another person whose information is provided by the recipient. Lastly if the recipient selects to reserve the amount, then a reserving step is initiated in which the drink amount is deposited into a designated account for later use.

In another embodiment, the redeeming step 707 may comprise of a providing step in which the recipient physically goes to a retailer such as a bar, restaurant, or club where drinks are served, and provides the confirmation code to an employee of the retailer. The retailer's employee then performs an authorizing step by entering the confirmation code into an authorization device. The authorization device may be a point of sale device or similar keypad. Once the confirmation code is entered, the sending step is initiated wherein the confirmation code is sent via the Internet to the appropriate database. At the database a comparing step is performed in which the confirmation code is compared with pre-stored data of the database. The results of the comparison are then sent back to the authorization device in the replying step. In the following confirming step, the retailer confirms whether or not the recipient would like to accept or decline the drink by entering the appropriate command into the authorization device. For example, if the recipient chooses to accept the drink then the retailer's employee enters the acceptance in the authorization device and distributes a drink in the amount authorized, alternatively, by simply entering in the confirmation code, the gift can be redeemed with no further action. Finally, the database will issue a payment to the retailer in an amount of the drink less a service charge.

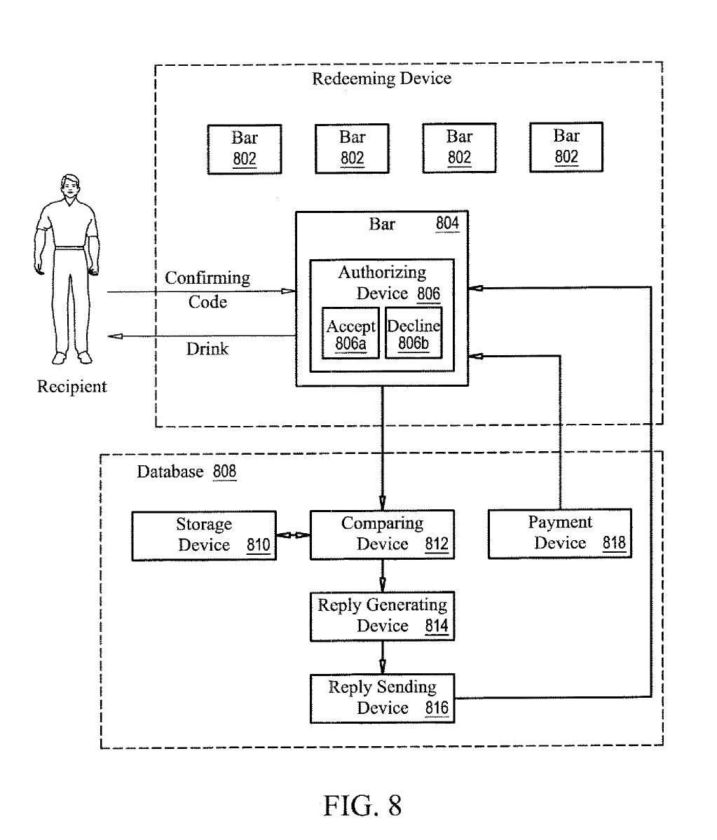

FIG. 8 illustrates one embodiment of the transaction system. This embodiment of the transaction system includes a network of retailers 802, a retailer 804, an authorizing device 806, a database 808, a storage device 810, a comparing device 812, a reply generating device 814, a reply sending device 816, and a payment device 818. In this embodiment, the item is redeemed through a retailer 804 belonging to a network of retailers 802. The network of retailers can be identified by a list located on a designated website or from stickers or similar markings located at the site of each retailer 804. A recipient physically travels to the site of a retailer 802. At the site of the retailer 804 is an authorizing device 806. This authorizing device 806 may be a keypad, a point of sale device, a credit card terminal, or similar device. Furthermore, the authorizing device 806 may comprise an accepting device 806a and a declining device 806b for accepting or declining the item respectively. Alternatively, the device may automatically redeem the gift code upon code entry. The accepting device 806a and declining device 806b may be buttons or similar actuating devices. The storage device 810 can be any computer memory device, such as ROM. The comparing device 812 may be any computer application or algorithm stored on a computer readable medium that is capable of comparing data received to data stored in memory. The reply generating device 814 may be any computer application or algorithm that is capable of generating a reply indicating whether or not the confirmation code is valid. The reply generating device 814 acts in response to the results of the comparing device 812. The reply sending device 816 is any device that is capable of interfacing with any communication system, including the internet and telephone system, in order to transmit the reply and any additional text or voice data. For example, the reply sending device 816 may be a modem. Furthermore, the reply sending device 816 may be capable of encrypting the data to be transmitted. Moreover, the reply sending device 816 may utilize any of the various encryption techniques used in the art. Finally, the payment device 818 may comprise any device such as a credit card terminal, which automatically sends the retailer 804 a payment if the item is accepted. Such a payment may include a check, electronic wire transfer, or a credit card payment.

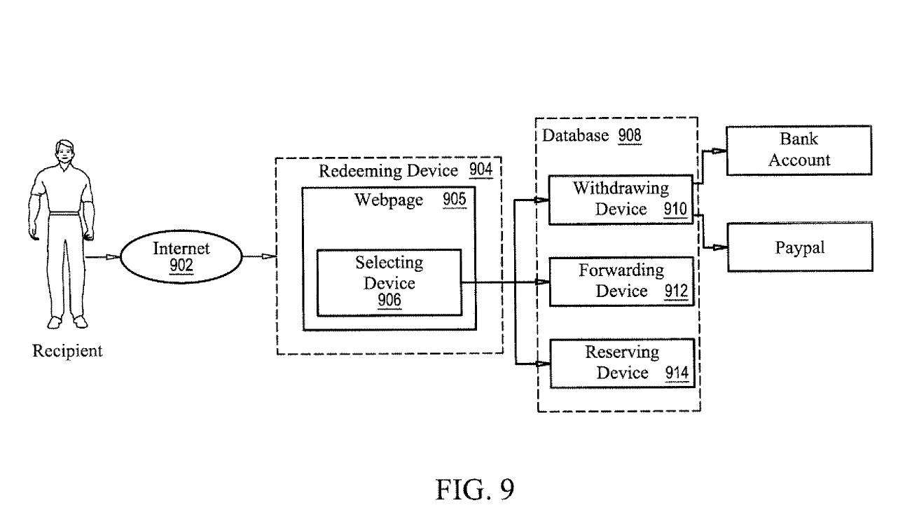

FIG. 9 illustrates another embodiment of the transaction system. This embodiment of the transaction system includes a network 902, a redeeming device 904 comprising an input device 905 and a selecting device 906, and a database 908 comprising a withdrawing device 910, a forwarding device 912, and a reserving device 914. The network 902 includes any communication network such as the internet or telephone network. The input device 905 may be any device capable of accepting input such as an online form at a designated redeeming website. The input device 905 must be able to accept the recipient's confirmation code. Furthermore, the input device 905 is coupled to a selecting device 906. The selecting device may be a hyperlink or similar selectable device. The selecting device 906 can control which device comprised in the redeeming device 904 is operated because the database 908 is coupled to the redeeming device 904. The withdrawing device 910 may be a computer application stored on a computer medium that is capable of depositing an item amount into a bank account or PayPal® account. The forwarding device 912 may be an online form that is allows for the transfer of the item to another recipient. Lastly, the reserving device 914 is a computer application stored on a computer medium that is capable of depositing the item amount to a designated account for later use.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of redeeming an item comprising:
a receiving step wherein a person who is to receive an item receives a notice of the item, the notice including a confirmation code; and
a redeeming step wherein the person uses the confirmation code to redeem the item.

2. The method of claim 1, wherein the notice is an electronic transmission.

3. The method of claim 1, wherein the notice is a physical transmission.

4. The method of claim 1, wherein the redeeming step further comprises:
an accessing step wherein the person accesses a designated website;
a submitting step wherein the person inputs the confirmation code at the designated website; and
a selecting step wherein the person then selects an item redeeming option.

5. The method of claim 4, further comprising the selecting step initiating a withdrawing step.

6. The method of claim 5, wherein the withdrawing step directly deposits the item into a bank account corresponding to a provided bank account routing number.

7. The method of claim 5, wherein the withdrawing step directly deposits the item into a PayPal account.

8. The method of claim 4, further comprising the selecting step initiating a forwarding step wherein the person gives the item to another person.

9. The method of claim 4, further comprising the selecting step initiating a reserving step wherein the person deposits the item into a designated account for later use.

10. The method of claim 1, wherein the redeeming step further comprises:
a providing step wherein the person provides the confirmation code to a retailer;
an authorizing step wherein the retailer inputs the confirmation code into an authorizing device;
a sending step wherein the authorizing device sends a message to a database;
a comparing step wherein the message is compared with data stored in the database;
a replying step wherein a reply, which indicates whether or not the confirmation code is valid and the item amount, is generated and sent to the authorizing device; and
a confirming step wherein the retailer confirms whether the person accepts or declines the item.

11. The method of claim 10, wherein the confirming step further comprises:
an accepting step wherein if the retailer accepts via the authorizing device then a payment is automatically sent to the retailer; and
a distributing step wherein if the retailer accepts via the authorizing device then the retailer distributes the item.

12. The method of claim 11, wherein the payment is selected from the group consisting of a check, wire transfer, and a credit card payment.

13. The method of claim 10, wherein the retailer is selected from the group consisting of a restaurant, a bar, and a club.

14. The method of claim 10, wherein the authorizing device is selected from the group consisting of a keypad, a point of sale device, and a credit card terminal.

15. A method of buying an item comprising:
an accessing step wherein a buyer accesses a designated website;
a buying step wherein the buyer enters information to buy an item;
a storing step wherein the information is stored in a database; and
a notifying step wherein the database sends a notice of the item to a person, the notice including a confirmation code.

16. A method of claim 15, wherein the information comprises the buyer's name, the buyer's email address, the buyer's credit card information, a person's name, the person's email address, an item amount, and a note.

17. A method of claim 16, wherein the information further comprises the person's cell phone number.

18. A method of claim 15, wherein the notice is an electronic transmission.

19. A method of claim 15, wherein the notice is a physical transmission.

20. A method of item giving, comprising:
an accessing step wherein a buyer accesses a designated website;
a buying step wherein the buyer enters information to buy an item;
a storing step wherein the information is stored in a database;
a notifying step wherein the database sends a notice of the item to a person;
a receiving step wherein the person receives the notice, the notice including a confirmation code; and
a redeeming step wherein the person uses the confirmation code to redeem the item.

21. The method of claim 20, wherein the notice is an electronic transmission.

22. The method of claim 20, wherein the notice is a physical transmission.

23. The method of claim 20, wherein the redeeming step further comprises:
an accessing step wherein the person accesses a designated website;
a submitting step wherein the person inputs the confirmation code at the designated website; and
a selecting step wherein the person then selects an item redeeming option.

24. The method of claim 20, wherein the redeeming step further comprises:
a providing step wherein the person provides the confirmation code to a retailer;
an authorizing step wherein the retailer inputs the confirmation code into an authorizing device;
a sending step wherein the authorizing device sends a message to a database;
a comparing step wherein the message is compared with data stored in the database;
a replying step wherein a reply, which indicates whether or not the confirmation code is valid and the item amount, is generated and sent to the authorizing device; and
a confirming step wherein the retailer confirms whether the person accepts or declines the item.

25. The method of claim 24, wherein the confirming step further comprises:
an accepting step wherein if the retailer accepts via the authorizing device then a payment is automatically sent to the retailer; and
a distributing step wherein if the retailer accepts via the authorizing device then the retailer distributes the item.

26. A system for consumer-to-consumer item giving, comprising:
a designated website that is accessible via the internet;
a buying device, such as an online form, that allows a buyer to enter information to buy an item;
a database that stores the information into a storage device, such as computer memory;
a confirmation code generating device, such as a computer application, that generates a confirmation code;
a notifying device, such as a modem, that sends a notice of the item to a person;
a receiving device, such as a cell phone, that allows the person to receive the notice, the notice including the confirmation code; and
a redeeming device, such as an online form, that accepts the confirmation code to redeem the item.

27. The system of claim 26, wherein the redeeming device further comprises:
an input device, such as an online form, for the person to input the confirmation code; and
a selecting device, such as a hyperlink, for allowing the person to select an item redeeming option.

28. The system of claim 27, wherein the selecting device initiates a withdrawing device, such as a computer application.

29. The system of claim 28, wherein the withdrawing device directly deposits the item amount into a bank account corresponding to a provided bank account routing number.

30. The system of claim 28, wherein the withdrawing device directly deposits the item amount into a PayPal account.

31. The system of claim 27, wherein the selecting device initiates a forwarding device, such as an online form, which forwards the item to another person.

32. The system of claim 27, wherein the selecting device initiates a reserving device, such as a computer application, which deposits the item into a designated account for later use.

33. The system of claim 26, wherein the redeeming device is a network of retailers.

34. The system of claim 33, wherein the network of retailers is a plurality of restaurants, bars, and clubs.

35. The system of claim 34, wherein each retailer in the network of retailers has an authorizing device that sends a message to the database.

36. The system of claim 35, wherein the database comprises:
a comparing device, such as a computer application, which compares the message to data in the storage device.
a reply generating device, such as a computer application, which generates a reply indicating whether or not the confirmation code is valid and the item amount.
a reply sending device, such as a modem, which sends the reply to the authorizing device.

37. The system of claim 36, wherein the authorizing device comprises an accepting device for accepting the item.

38. The system of claim 37, wherein the database further comprises a payment device, such as a credit card terminal, which initiates a transaction that sends the retailer a payment if the item was accepted.

39. The system of claim 38, wherein the payment is selected from the group consisting of a check, wire transfer, and a credit card payment.

40. The system of claim 35, wherein the authorizing device is one of the group consisting of a keypad, a point of sale device, and a credit card terminal.
